(19) United States
(12) Patent Application Publication
(10) Pub. No.: US 2007/0071933 A1
(43) Pub. Date: Mar. 29, 2007

(54) Article and method

(76) Inventors: Fabrizio Gavelli, Forli (IT); Neil Campbell Muir, Dansom Lane (GB); Shaun Rymer, Dansom Lane (GB)

Correspondence Address: NORRIS, MCLAUGHLIN & MARCUS, 875 THIRD AVE, 18TH FLOOR, NEW YORK, NY, 10022, US

(21) Appl. No.: 10/576,770

(22) PCT Filed: Sep. 9, 2004
(86) PCT No.: PCT/GB04/03855

§ 371 Date: Apr. 21, 2006

(30) Foreign Application Priority Data
Oct. 24, 2003 (GB) 0324756.6

(51) Int. Cl. G09F 3/00; B32B 27/04; B32B 5/02; B32B 5/16

(52) U.S. Cl. 428/43; 442/417; 442/96

(57) ABSTRACT

The invention provides an odour-reducing sheet (2) divided by lines of perforation (4, 6) into a plurality of tear-off pieces (8). The invention also extends to an odour-control kit employing such a sheet, and to a method of removing reducing odours at a selected locus.

This invention relates to an odour-reducing article and to a method of removing or mitigating odours.

Through everyday use, unpleasant or unwanted odours may become adsorbed by substrates, especially textile substrates such as clothing and mattresses. There are products on the market such as compositions which may be sprayed onto textile substrates to mask unpleasant or unwanted odours. Such compositions only serve to hide the odours for a limited period of time and can themselves cause the textile substrates to take on an unwanted perfumed smell.

According to a first aspect of the invention there is provided an odour-reducing is sheet divided into a plurality of tear-off pieces.

By “odour-reducing” we denote odour-removal as well as alteration from a first, higher level of odour to a second, lower level of odour.

Suitably the sheet is of non-woven material, and is preferably a non-woven fibrous web or mat.

The sheet is preferably air permeable.

Suitable materials for the sheet include polyesters, polyamides, cellulosics (for example rayon and viscose) and nylon, or mixtures thereof for example. The sheet may alternatively comprise natural fibres, such as cotton, linen, flax and wool, or mixtures thereof, for example. The sheet may comprise a mixture of synthetic and natural fibres.

Suitably the sheet is comprised of synthetic fibres formed into a web, mat or similar flexible sheet-form substrate. The sheet material may be a laminar composite material of layers of non-woven fibres, woven fibres or mixtures thereof which layers may comprise the same or different materials. Preferably, however, it is one-layer form.

Most preferably the sheet comprises fibres of polyester or cellulosic material, including viscose and rayon; viscose being especially preferred.

Odour-reducing materials may be selected according to the intended use and odours to be absorbed, and include carbon, zeolites, inorganic compounds such as silica and metal oxides e.g. of titanium (TiO₂), zinc (ZnO) and aluminium and mixtures thereof, and may be in crystalline, microcrystalline, granular or other particulate form, for example.

Preferably the odour-reducing material reduces odour by adsorbing molecules responsible for odour. Most preferred as an odour-reducing material is activated carbon, preferably in particulate form. The activated carbon may take the form of charcoal, peat, coconut shell, lignite or wood, for example but is preferably charcoal.

Particle sizes for suitable odour-reducing materials depend on the material selected but will typically be between about 0.1 μm to about 300 μm, preferably: up to about 75 μm, and preferably not less than 1 μm, more preferably not less than 25 μm, these values being nominal (mean) diameters.

Suitably the odour-reducing material is present in the sheet in an amount of at least 5% (w/w), preferably at least 10% (w/w), more preferably at least 15% (w/w), still more preferably at least 20% (w/w), yet more preferably at least 25% (w/w), and most preferably at least 30% (w/w), of the total weight of the sheet.

Suitably the odour-reducing material is present in the sheet in an amount of no more than 60% (w/w), preferably no more than 50% (w/w), more preferably no more than 45% (w/w), and most preferably no more than 40% (w/w), of the total weight of the sheet.

Preferably the sheet comprises fibres and odour-reducing material in a ratio of 0.3-3, more preferably 0.5-2 to 1, most preferably 0.8-1.2 to 1, parts fibres to 1 part odour-reducing sheet (w/w).

Suitably the odour-reducing material is retained or impregnated within the sheet, preferably using a fixing agent, and whereby in use shedding of the odour-reducing material is inhibited, preferably substantially avoided. Preferably shedding of fibres (when employed) is inhibited, and preferably substantially avoided, either by virtue of the fibrous material selected, or the fixing agent, or both.

Suitably the fixing agent comprises a binder, and preferably a film-forming agent. Suitable binders include a latex, such as an acrylic-based or styrene-butadiene-based aqueous emulsion or natural rubber-based binder.

Auxiliary components may be present, selected from one or more of an organic solvent, dispersant, surfactant, emulsification aid, anti-oxidant, flocculant, viscosity modifier, film former and anti-foaming agent. The term film former means a material capable of forming a film when dry at ambient temperature and pressure. Suitable film-formers include polyvinyl alcohol or polyvinyl alcohol/vinyl acetate copolymers, and quaternary ammonium salts of polyvinylpyrrolidone/vinyl acetate copolymers. Suitable surfactants and/or emulsification aids include anionic, cationic, non-ionic and amphoteric surfactates.

Suitably impregnation of the sheet with the odour-reducing, preferably odour adsorbing, material is carried out using a liquid containing the odour-reducing material, preferably also comprising the fixing agent, by any one or more of the following methods:
saturation by soaking in a convenient manner e.g. simply delivery of the liquid from a hose over the sheet;
impregnation by immersion of the sheet in a bath of the liquid;
forced impregnation into the sheet by application of the liquid under pressure;
pouring of the liquid over the sheet by a curtain-coating device situated over a progressively advancing web of sheet to drench the sheet; and
spraying the liquid upon the sheet.

Preferably the liquid is aqueous.

Most preferably the liquid comprises the fixing agent in aqueous emulsion form, with the odour-reducing material in particulate form, and suspended in the liquid.

Suitably the binder comprises at least 5% (w/w) of the total weight of the sheet, preferably at least 10% (w/w), more preferably at least 20% (w/w), yet more preferably at least 25% (w/w), and most preferably at least 32% (w/w).

Suitably the binder comprises up to 65% (w/w) of the total weight of the sheet, preferably up to 58% (w/w), more preferably up to 50% (w/w), and most preferably up to 45% (w/w).

Preferably said binder provides 70-100%, more preferably 85-100% (w/w) of the fixing agent, with said auxiliary component(s) in total providing 30-0% (w/w), more preferably 15-0% (w/w). Most preferably the binder provides 90-99% (w/w) of the fixing agent and said auxiliary component(s) in total provides 10-1% (w/w).

Preferably the sheet comprises fibres and binder in a ratio of 0.3-3, more preferably 0.5-2 to 1, most preferably 0.8-1.2 to 1, parts fibres to 1 part binder (w/w).

The sheet and/or odour-reducing material may be as further described in WO 98/303026.

Preferably the sheet is divided into a plurality of tear-off pieces by way of lines of perforation. Preferably these perforations are sufficiently coarse, that the user can see them, and so knows where to tear, when it is wished to do so. Alternatively or additionally lines of weakness—for example thinned regions—may be provided where pieces are to be separated.

In one embodiment the sheet is formed with a small piece of the material of the sheet absent (preferably punched out) at each intersection between lines of perforation. Preferably each such piece is a square whose corners are aligned with the perforations.

Alternatively or additionally—preferably additionally—the sheet is formed with a small piece of the material of the sheet absent (preferably punched out) at each intersection between an edge of the sheet and a line of perforation. Preferably each such piece is a V-shaped piece whose apex is aligned with the line of perforations. Thus the edges may be “unotched” at intervals. By such means tearing along the desired lines of perforations may be improved. The likelihood of ragged tearing occurring away from the lines of perforation is reduced.

Alternatively or additionally markings may be provided on the sheet to indicate where pieces may readily be separated.

Preferably the sheet is divided into at least four tear-off pieces, more preferably at least eight tear-off pieces, and most preferably at least twelve tear-off pieces.

Preferably the sheet is at least 0.4 m² in area, preferably at least 0.6 m². Suitably it is up to 1.2 m² in area, preferably up to 1 m².

Preferably the sheet is divided into a plurality of tear-off pieces of area at least 400 cm², preferably at least 500 cm². Preferably the area of tear-off pieces does not exceed 1200 cm², and preferably does not exceed 1000 cm².

Preferably the sheet is rectangular. Preferably at least some of the tear-off pieces, and preferably all of them, are rectangular.

In preferred embodiments the tear-off pieces are identical to each other, but in other embodiments need not be so.

A sheet of the invention may be used as such to adsorb odours from a large area. For example it may be placed under a rug or mattress. Alternatively it may be divided into one or more pieces, without the user having to cut the sheet. For example a piece—perhaps made up of two or three of the smallest tear-off pieces, may be torn off to line a pet basket or laundry basket; or a single tear-off piece may be torn off and stuffed into musty shoes. Larger pieces may be torn off to line a drawer. Pieces may be torn off to place inside a plastics closure, along with items requiring deodorising, for example pet collars.

In accordance with a second aspect of the present invention there is provided an odour-control kit, comprising an odour-reducing sheet of the first aspect and a resealable plastics closure. Optionally the kit includes adhesive strips which a user can employ in order to fashion a simple enclosure from the odour-reducing sheet itself. For example the sheet can be folded in two so that a jacket or coat can be placed between the folds. The jacket or coat can be placed on a clothes hanger and the hanging hook of the hanger can simply pushed through the material of the sheet, so that the assembly of shroud-like odour-reducing sheet and the jacket or coat can be hung up. If the user wishes he or she can use adhesive strips to hold the edges of the folds tog ether, so that the sheet forms a snug enclosure, in the form of a shroud, around the jacket or coat. Optionally the kit includes at least one clothes hanger.

In accordance with a further aspect of the invention there is provided a method of reducing odour at a selected locus, preferably by adsorption, using a sheet of the first aspect of the invention formed into a shroud-like form, or of tear-off portions of such a sheet, the portions having been tom from the sheet along perforations provided, the sheet or portions thereof being disposed at a locus in which the odours are present; preferably in close proximity to a source of such odours. For example the sheet or portions thereof may be placed in contact with odouriferous articles.

Preferably the odour-reducing sheet is not itself a garment, or a fabric item used per se (as, for example, an item of bed linen, table linen, a drying cloth, towel, etc).

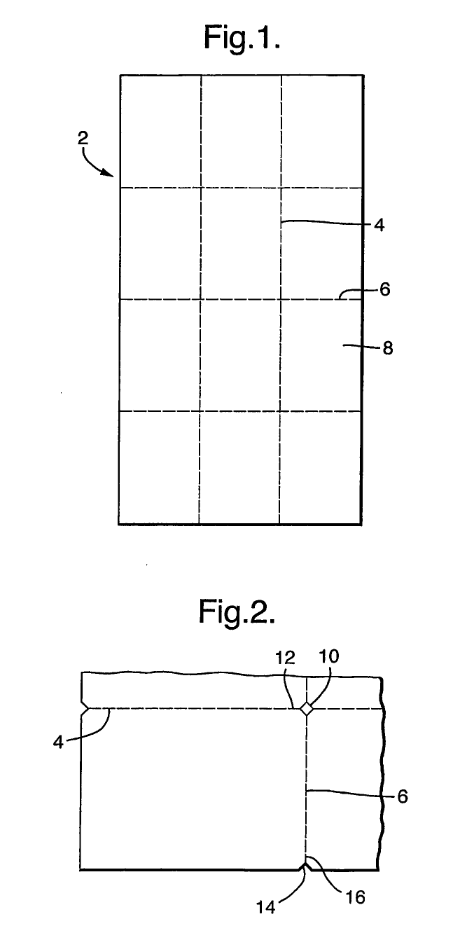

In order to better understand the various aspects of the invention and to show how an embodiment of the same may be put into effect, the invention will now be described by way of example, with reference to FIGS. 1 and 2, which depict alternative embodiments, in plan view.

With reference to FIG. 1, the deodorising sheet 2 of this example is a rectangle of size 120×63 cm. It weighs 76 g; thus it is of grammage c. 100 gsm. It is formed with large, easily visible perforations, two lengthwise, indicated by reference 4, and three crosswise, indicated by reference 6, into a grid of 4×3 A4-sized tear-off pieces 8. A4 pieces or multiples thereof can be torn from it by the user, if they wish.

The sheet and/or odour-reducing material are essentially as described in WO 98/303026. In this embodiment the odour-reducing material removes odoriferous molecules from the locus of use by adsorption.

The sheet material in this example is as follows:

Viscose fibres 35% (viscose rayon fibres/regenerated cellulose—CAS No. 68442-85-3.

Activated carbon 25% (steam activated carbon, CAS No. 7440-44-0.

Acrylic binder 32.5% (VINACRYL 4347 (Trade Mark), an aqueous emulsion of a butyl acrylate/acrylonitrile polymer.

PVA film-former 0.5% (MOWIOL 4-88 (Trade Mark), partially saponified polyvinyl alcohol, CAS No.25213-24-5).

Antifoamer 1.0% (polydimethylsiloxane, product name DP 98/033). (all weight/total sheet weight)

The sheet is a non-woven construction. The viscose fibres, having a length of 30-50 mm, are formed into the sheet material comprising a fibrous web by a carding process, which is impregnated with activated carbon particles, of mean diameter 25-75 μm. The activated carbon particles are the odour-adsorbing material.

The sheet is impregnated with the activated carbon by a process of immersing the sheet in a bath of treatment liquor in which activated carbon is present. The treatment liquor comprises the further materials mentioned above, in which the activated carbon is in suspension. During immersion of the sheet the charcoal is taken up into the fibrous web and held in place by the fixing agent (comprising the binder and the film-former) to prevent shedding.

The sheet is air permeable. The sheet is monolithic (i.e. it is not a laminate). Its thickness is 0.25 mm ±0.1 mm.

During manufacture the sheet is cut full width from a web of material, into its full size, then perforated using a perforator which removes slits of material so that the perforation lines are readily visible. It is then folded along the lines of perforation, into an A4 footprint. It is sold with a resealable plastics bag and with adhesive strips, and hangers, as an odour-control kit.

The sheet can be used in many ways. For example a user could simply fold the sheet into two, and locate an item of clothing (e.g. a suit) between the folds. The sides could be held together with the adhesive strips if wished. If the sheet was folded along the top of the suit a hook of a hanger for a garment could be pushed through the sheet. Alternatively one or more pieces, A4 or larger, could be removed to line a clothes drawer, a washing basket, pet basket, car boot and so on. Alternatively, A4 pieces could be removed and bunched up and put into an item of footwear, for example a shoe or boot.

The embodiment of FIG. 2 corresponds to that of FIG. 1 other than in having two differences.

Firstly, during manufacture small squares 10 of material have been punched out at each intersection between lines of perforation 4, 6. The corners of the squares are aligned with the respective perforations. Each corner runs into an individual perforation, such as perforation 12 shown in FIG. 2. Each square is of side 8 mm in this embodiment.

Secondly, a small notch 14 of material is removed at each intersection between an edge of the sheet and a line of perforation. Each notch is V-shaped, and its apex is aligned with a line of perforations. The final individual perforation 16 runs into the notch. The two sides of the notch which are contiguous are both of them of length 8 mm.

The purpose of each of these differences from the FIG. 1 embodiment is to facilitate accurate tearing along the desired line of perforations.

1. An odour-reducing sheet divided into a plurality of tear-off pieces, wherein the sheet comprises a non-woven, air permeable fibrous material which carries an odour-adsorbing material selected from carbon, a zeolite, titanium dioxide, zinc oxide, aluminium, and mixtures thereof.

2. An odour-reducing sheet according to claim 1, wherein the odour-adsorbing material comprises particulate activated carbon.

3. An odour-reducing sheet according to claim 1, wherein the odour-adsorbing material is present in the sheet in an amount of at least 5% (w/w) of the total weight of the sheet.

4. An odour-reducing sheet according to claim 1, wherein the odour-adsorbing material is present in the sheet in an amount of no more than 60% (w/w) of the total weight of the sheet.

5. An odour-reducing sheet according to claim 1, wherein the odour-adsorbing material comprises a binder arranged to inhibit or substantially avoid shedding of the odour-reducing material from the sheet.

6. An odour-reducing sheet according to claim 5, wherein the binder is present in the sheet in an amount of at least 5% (w/w), of the total weight of the sheet.

7. An odour-reducing sheet according to claim 1, wherein the sheet comprises polyester, polyamide, cellulosic or polyamide fibres, or a mixture thereof.

8. An odour-reducing sheet according to claim 1, wherein the sheet is divided into a plurality of tear-off pieces by perforations.

9. An odour-reducing sheet according to claim 1, wherein the sheet is of area in the range 0.4-1.2 m 2 and is divided into a plurality of tear-off pieces each of area in the range 400-1000 cm 2.

10. An odour-control kit comprising an odour-reducing sheet according to claim 1 and a resealable plastics closure, and optionally adhesive strips and at least one clothes hanger.

11. A method of reducing odours using an odour-reducing sheet according to claim 1, or of portion(s) thereof, the portion(s) having been torn from the sheet, the sheet or portion(s) thereof being disposed at a locus in which the unwanted odours are present.

12. A method according to in claim 11, wherein the odour-reducing sheet or portion(s) thereof are used in one of the following ways: placed under a mat, rug or carpet; placed under or over a mattress; placed in a pet basket; placed in a laundry basket; placed in luggage before storage; placed in a car footwell or car boot; placed under a fitted chair or sofa cushion; placed inside an item or footwear, for example a shoe or boot; used to line a drawer; placed in a plastics closure with items requiring deodorising; or fashioned into a shroud-like cover inside which a jacket, coat, suit or trousers are placed.
